(19) United States
(12) Patent Application Publication
(10) Pub. No.: US 2002/0106072 A1
(43) Pub. Date: Aug. 8, 2002

(54) Method and apparatus for improving gain bandwidth paths

(76) Inventor: Russell J. Apfel, Austin, TX (US)

Correspondence Address: Terry D. Morgan, Williams, Morgan & Amerson, P.C., Suite 250, 7676 Hillmont, Houston, TX, 77040, US

(21) Appl. No.: 09/778,291

(22) Filed: Feb. 6, 2001

(51) Int. Cl. H04M 1/00; H04M 3/00

(52) U.S. Cl. 379/347

(57) ABSTRACT

A method and apparatus is provided for improving at least one gain bandwidth path. At least one signal being transmitted is monitored. A gain/bandwidth control process is performed upon the monitoring of the signal. The apparatus taught by the present invention comprises: a first circuit portion capable of driving a signal onto a subscriber line; and a second circuit portion electrically coupled with the first circuit portion, wherein the second circuit portion is capable of separating a plurality of signal paths based upon at least one characteristic of the signal path for applying an appropriate gain factor upon the signal path.

### BACKGROUND OF THE INVENTION

1. Field of the Invention This invention relates generally to telecommunications, and, more particularly, to using controlling gain in correspondence to bandwidth of signals.

2. Description of the Related Art

In communications systems, particularly telephony, it is common practice to transmit signals between a subscriber station and a central switching office via a two-wire bi-directional communication channel. A line card generally connects the subscriber station to the central switching office. The primary functions of the line card range from supplying talk battery to performing wake-up sequences of circuits to allow communications to take place.

The Plain Old Telephone System, designed primarily for voice communication, provides an inadequate data transmission rate for many modern applications. To meet the demand for high-speed communication, designers have sought innovative and cost-effective solutions that would take advantage of the existing network infrastructure. Several technological solutions proposed in the telecommunications industry use the existing network of telephone wires. A promising one of these technologies is the xDSL technology.

xDSL is making the existing network of telephone lines more robust and versatile. Once considered virtually unusable for broadband communications, an ordinary twisted pair equipped with DSL interfaces can transmit video, television, and very high-speed data. The fact that more than six hundred million telephone lines exist around the world is a compelling reason for these lines to be used as the primary transmission conduits for at least several more decades. Because DSL utilizes telephone wiring already installed in virtually every home and business in the world, it has been embraced by many as one of the more promising and viable options.

There are now at least three popular versions of DSL technology, namely Asymmetrical Digital Subscriber Line (ADSL), Very High-Speed Digital Subscriber Line (VDSL), and Symmetric Digital Subscriber Line (SDSL). Although each technology is generally directed at different types of users, they all share certain characteristics. For example, all four DSL systems utilize the existing, ubiquitous telephone wiring infrastructure, deliver greater bandwidth, and operate by employing special digital signal processing. Because the aforementioned technologies are well known in the art, they will not be described in detail herein.

DSL and Plain Old Telephone System technologies can co-exist in one line (e.g., also referred to as a “subscriber line”). Traditional analog voice band interfaces use the same frequency band, 0-4 Kilohertz (KHz), as telephone service, thereby preventing concurrent voice and data use. A DSL interface, on the other hand, operates at frequencies above the voice channels, from 25 KHz to 1.1 Megahertz (MHz). Standards for certain derivatives of DSL are still in definition, and, therefore, are subject to change. Thus, a single DSL line is capable of offering simultaneous channels for voice and data. It should be noted that the standards for certain derivatives of ADSL are still in definition as of this writing, and therefore are subject to change.

DSL systems use digital signal processing (DSP) to increase throughput and signal quality through common copper telephone wire. It provides a downstream data transfer rate from the DSL Point-of-Presence (POP) to the subscriber location at speeds of up to 1.5 mega-bits per second (MBPS). The transfer rate of 1.5 MBPS, for instance, is fifty times faster than a conventional 28.8 kilobits per second (KBPS).

DSL systems generally employ a signal detection system that monitors the telephone line for communication requests. More specifically, the line card in the central office polls the telephone line to detect any communication requests from a DSL data transceiver, such as a DSL modem, located at a subscriber station. There are multiple types of signals that are received and transmitted over multiple signal paths during telecommunication operation. Different signals have different bandwidth, gain, and accuracy requirements. The methods employed in today's communication systems to process communication signals produces inefficiency in noise and accuracy issues in signals.

The present invention is directed to overcoming, or at least reducing the effects of, one or more of the problems set forth above.

### SUMMARY OF THE INVENTION

In one aspect of the present invention, a method is provided for improving at least one gain bandwidth path. At least one signal being transmitted is monitored. A gain/bandwidth control process is performed upon the monitoring of the signal.

In another aspect of the present invention, an apparatus is provided for improving at least one gain bandwidth path. The apparatus taught by the present invention comprises: a first circuit portion capable of driving a signal onto a subscriber line; and a second circuit portion electrically coupled with the first circuit portion, wherein the second circuit portion is capable of separating a plurality of signal paths based upon at least one characteristic of the signal path for applying an appropriate gain factor upon the signal path.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a first embodiment of an apparatus in accordance with the present invention;

FIG. 2 depicts an embodiment of a method in accordance with the present invention that can be implemented by the apparatus of FIG. 1;

FIG. 3 illustrates a more detailed depiction of the apparatus in accordance with the pre sent invention;

FIG. 4 illustrates a more detailed depiction of one embodiment of the gain/bandwidth controller described in FIG. 3;

FIG. 5A illustrates a more detailed depiction of the SLIC and the gain/bandwidth controller, in accordance with one embodiment of the present invention;

FIG. 5B shows a simplified block diagram illustrating the signal separation for performing separate gain control, in accordance with the present invention.

FIG. 6 illustrates a flowchart representation of one embodiment of the method in accordance with the present invention; and

FIG. 7 illustrates a more detailed representation of the step of performing a gain/bandwidth control process described in FIG. 5A.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

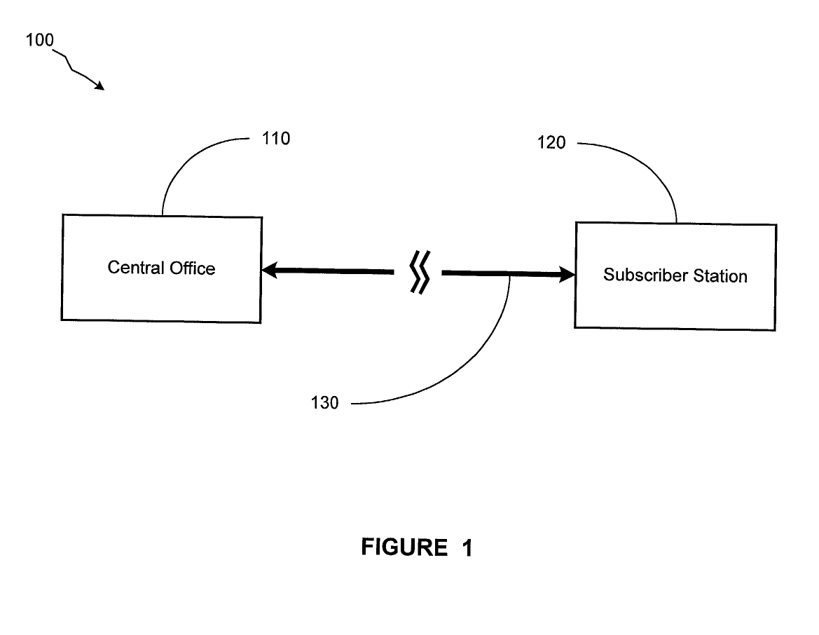

Referring now to the drawings, and in particular to FIG. 1, an apparatus 100 in accordance with the present invention is illustrated. The apparatus 100 in FIG. 1 includes a central office 110 that is coupled a subscriber station 120 via a subscriber line 130. The central office 110 and the subscriber station 120 are capable of sending and receiving a signal comprising voice and data band. The voice band, as used herein, refers to a POTS voice signal ranging from 0-4 KHz. The data band refers to frequencies above the voice band, and may include, for example, the frequency range employed in xDSL technologies. In one embodiment, the subscriber line 130 may be a Public Switched Telephone Network (PSTN) line, a Private Branch Exchange (PBX) line, or any other medium capable of transmitting signals.

The subscriber station 120 may be a telephonic device capable of supporting pulse dialing. The term “telephonic device,” as utilized herein, includes a telephone, or any other device capable of providing a communication link between at least two users. In one embodiment, the subscriber station 120 may be one of a variety of available conventional telephones, such as wired telephones and similar devices. In an alternative embodiment, the subscriber station 120 may be any “device” capable of performing a substantially equivalent function of a conventional telephone, which may include, but is not limited to, transmitting and/or receiving voice and data signals. Examples of the subscriber station 120 include a data processing system (DPS) utilizing a modem to perform telephony, a television phone, a wireless local loop, a DPS working in conjunction with a telephone, Internet Protocol (IP) telephony, and the like. IP telephony is a general term for the technologies that use the Internet Protocol's packet-switched connections to exchange voice, fax, and other forms of information that have traditionally been carried over the dedicated circuit-switched connections of the public switched telephone network (PSTN). One example of IP telephony is an Internet Phone, a software program that runs on a DPS and simulates a conventional phone, allowing an end user to speak through a microphone and hear through DPS speakers. The calls travel over the Internet as packets of data on shared lines, avoiding the tolls of the PSTN.

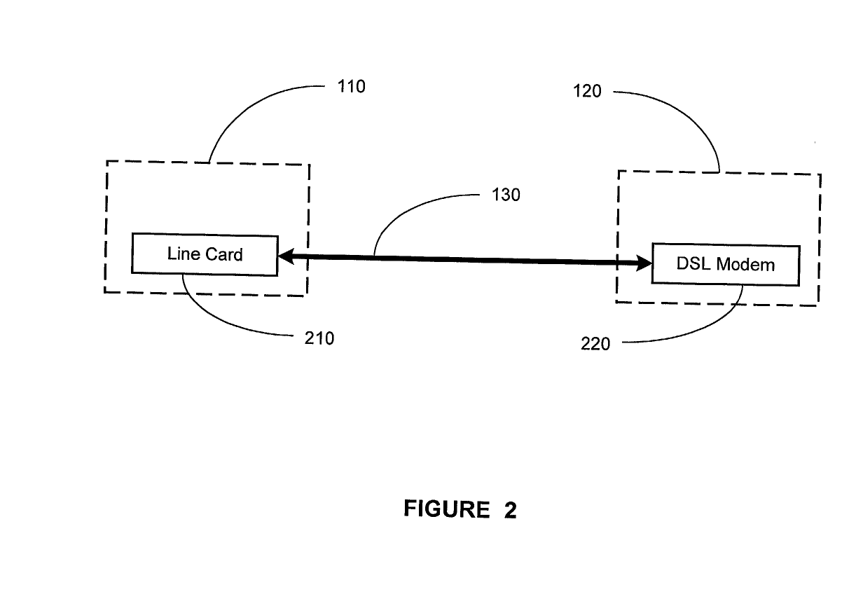

Turning now to FIG. 2, a line card 210 and a DSL modem 220 are illustrated in accordance with the present invention. In one embodiment, the line card 210, which is integrated into the central office 110, is coupled with the DSL modem 220, which resides within the subscriber station 120. Because voice and/or data can be transmitted on the subscriber line 130, the signal received and transmitted by the line card 210 and the DSL modem 220 may include voice and data band frequencies.

The line card 210 may be located at a central office or a remote location somewhere between the central office and the subscriber station 120 (see FIG. 1). The line card 210 services the subscriber station 120, which in the illustrated embodiment is a telephonic device. The line card 210 is capable of processing DC voltage signals and AC signals. The subscriber line 130 (see FIG. 1) in the instant embodiment is a telephone line. The combination of the telephone device and the telephone line is generally referred to as a subscriber loop.

The line card 210, which may be capable of supporting a plurality of subscriber lines 130, performs, among other things, two fundamental functions: DC loop supervision and DC feed. The purpose of DC feed is to supply enough power to the telephone device 220 at the customer end. The purpose of DC loop supervision is to detect changes in DC load, such as on-hook events, off-hook events and rotary dialing, or any other event that causes the DC load to change. In the interest of clarity and to avoid obscuring the invention, only that portion of the line card 210 that is helpful to the understanding of the invention is illustrated.

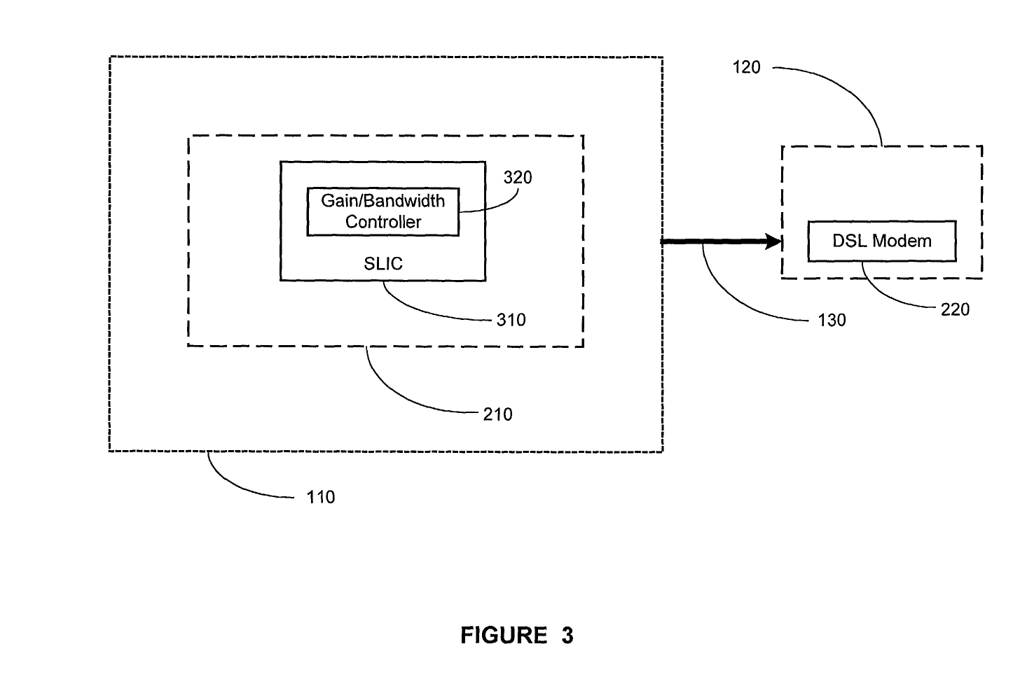

Turning now to FIG. 3, one embodiment of an implementation of a gain/bandwidth controller 320 as taught by the present invention is illustrated. In one embodiment, the line card 210 comprises a subscriber line interface circuit (SLIC) 310. The SLIC 310 is capable of performing a variety of functions, such as signal gain functions, battery feed, overload protection, polarity reversal, on-hook transmission, and current limiting.

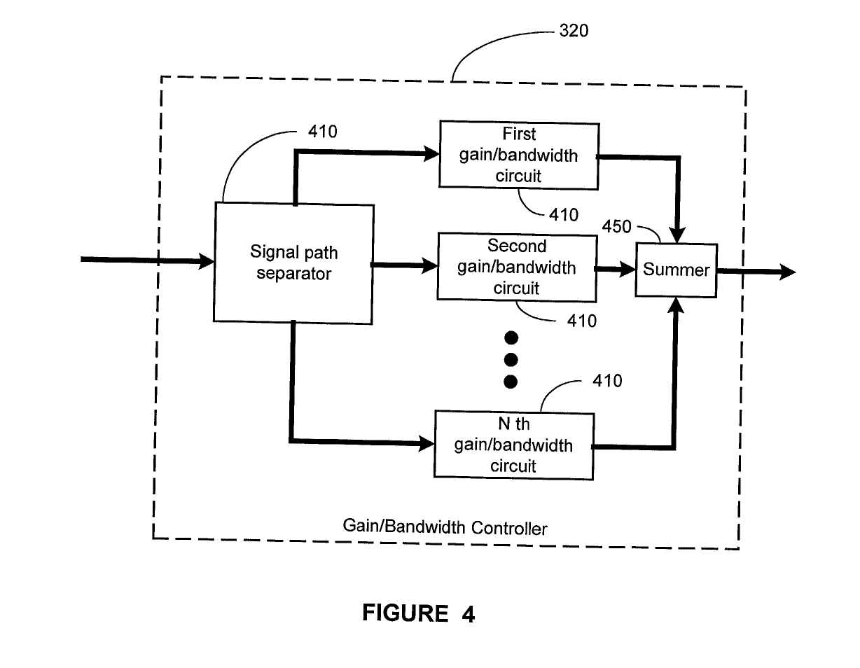

In one embodiment, the SLIC 310 comprises a gain/bandwidth controller 320 that is capable of controlling the gain of a plurality of signals. In one embodiment, the gain/bandwidth controller 320 controls the gain and accuracy of a plurality of signal in both directions, the upstream direction (i.e. from the subscriber station 120 to the central office 110) and the downstream direction (i.e. from the central office 110 to the subscriber station 120). FIG. 4 illustrates one embodiment of a more detailed depiction of the gain/bandwidth controller 320.

Turning now to FIG. 4, the gain/bandwidth controller 320 comprises a signal path separator 410, a first gain/bandwidth circuit 420, a second gain/bandwidth circuit 430, an Nth gain/bandwidth circuit 440, and a summer 450. In one embodiment, the signal path separator 410 is capable of generating a separate signal path for a plurality of signals based upon the bandwidth requirement of a particular signal. The separated signal paths are sent to the first through Nth gain/bandwidth circuit 420, 430, 440. The first through Nth gain/bandwidth circuit 420, 430, 440 then performs an appropriate gain upon the signal they receive, respectively. For example, the ringing signal may need a gain of 140, whereas a voice signal may only need a gain of 2 or 3. The gain that is applied to the signal paths may be determined by a plurality of factors that are known to those skilled in the art, including the approximate total length of the signal path of a particular signal and the required accuracy of a particular signal.

The signal path separator 410 sends separated signals path to one of the first through Nth gain/bandwidth circuit 420, 430, 440. For example, the signal path separator 410 is may separate a voice signal that has a bandwidth requirement of 200 Hertz to 20 KiloHertz. The signal path separator 410 then sends the signal path that contains the voice signal to the first gain/bandwidth circuit 420, where a gain of approximately 2 or 3 is applied onto the signal. The signal path separator 410 may separate a DC or ringing signal that has a bandwidth requirement of 100 Hertz to 200 Hertz. The signal path separator 410 then sends the signal path that contains the DC or ringing signal to the second gain/bandwidth circuit 430, where a gain of approximately 140 is applied. As an another illustrative example, the signal path separator 410 may separate a data signal that has a bandwidth requirement of 500 KiloHertz to 5 Megahertz. The signal path separator 410 then sends the signal path that contains the data signal to the Nth gain/bandwidth circuit 440, where a gain of approximately 10 is applied. The gain/bandwidth controller 320 is capable of separating other types of signal and applying an appropriate gain upon the signal path.

Once the gain/bandwidth controller 320 separates the signal paths and applies an appropriate gain onto the signal on the signal path, the signals from multiple signal paths are summed by the summer 450. Once the summer 450 sums the signal from the first through Nth gain/bandwidth circuit 420, 430, 440, the signal is sent off the gain/bandwidth controller 320 for normal processing. The gain/bandwidth controller 320 can be used to apply separate signal gains corresponding to a plurality of bandwidth and accuracy requirements in the upstream and the downstream direction. The utilization of the gain/bandwidth controller 320 allows for improved noise performance of the line card 210. Furthermore, use the gain/bandwidth controller 320 improves the accuracy of communication signals because signal accuracy issues can be addressed upon an individual signal basis. For example, the data path signal may not need as much accuracy as the DC signal or the voice signal, therefore separate gains may be applied on the data, voice, and DC signals.

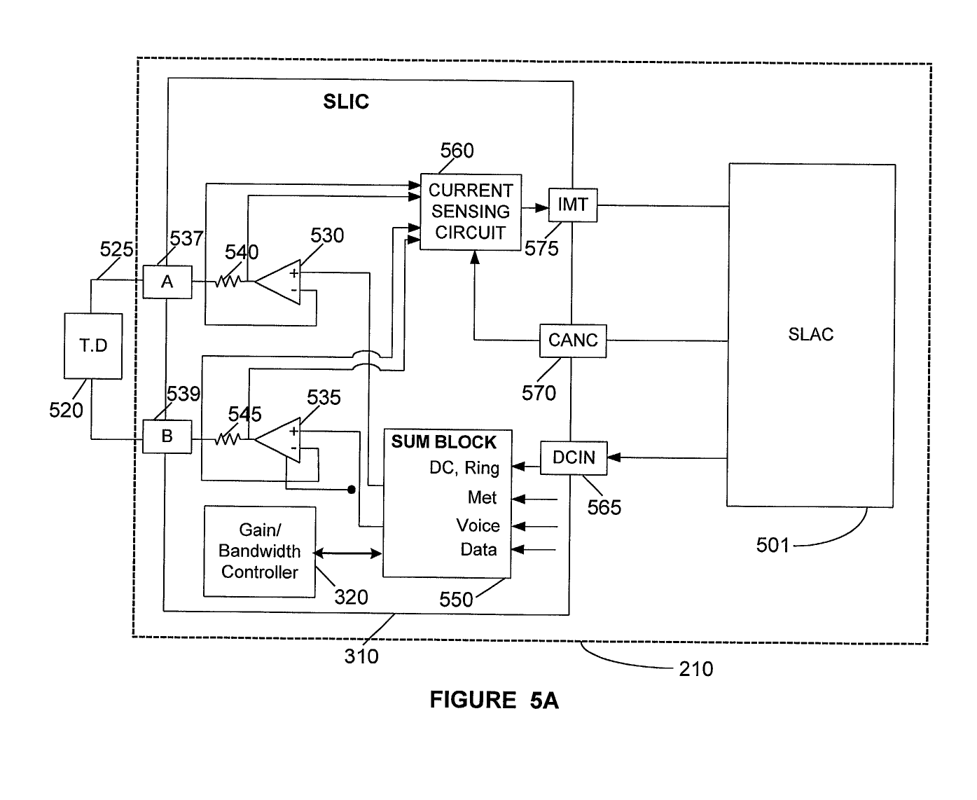

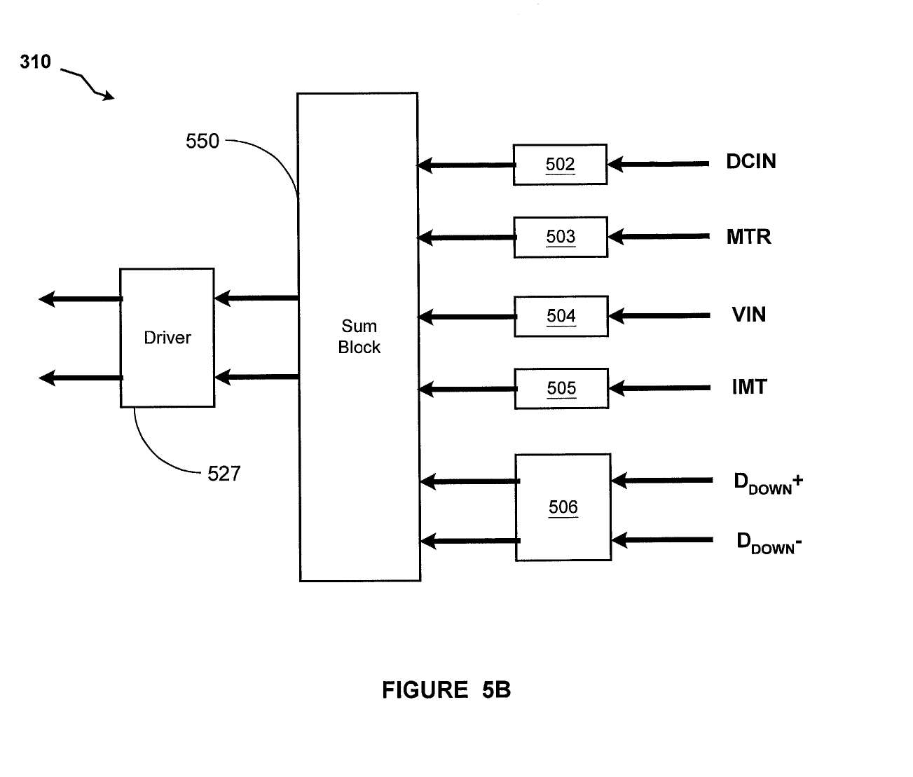

One embodiment of implementing the gain/bandwidth controller 320 into the SLIC 310 is illustrated in FIG. 5A. A line card 210 typically includes at least one SLIC 310 as well as a subscriber line audio-processing circuit (SLAC) 501, as illustrated in FIG. 5A. The SLIC 310 is capable of performing a variety of functions, such as battery feed, overload protection, polarity reversal, on-hook transmission, and current limiting. The SLIC 310 is connected to the SLAC 501. The SLAC 501 is capable of processing analog-to-digital (A/D) and digital-to-analog (D/A) signal conversion, filtering, feed control, and supervision.

In one embodiment, the SLIC 310 is a voltage-feed SLIC 310. The voltage-feed SLIC 310 is a high voltage bipolar SLIC that drives voltages to the telephone line 525 and senses current flow in the telephone line 525. The SLIC 310 includes first and second differential line drivers 530, 535 that interface with a telephone line 525 via tip and ring terminals 537, 539. The telephone line 525 is coupled with a telephonic device 520. The term “telephonic device,” as utilized herein, includes a telephone, or any other device capable of providing a communication link between at least two users. The tip terminal 537 is coupled to a first terminal of a first sensing resistor (R_{ab}) 540 and to an inverting terminal of the first line driver 530. A second terminal of the first sensing resistor 540 is coupled to an output terminal of the first line driver 530. The ring terminal 539 is coupled to a first terminal of a second sensing resistor (R_{bd}) 545 and to an inverting terminal of the second line driver 535. A second terminal of the second sensing resistor 545 is coupled to an output terminal of the second line driver 535.

The SLIC 310 includes a sum block 550 and a current-sensing circuit 560. The sum block 550 includes a first output terminal coupled to a non-inverting terminal of the first line driver 530, and a second (inverted) output terminal coupled to a non-inverting terminal of the second line driver 535. The sum block 550 is capable of receiving a DC feed signal (as well as metering and ringing signals) from a DCIN terminal 565, a voice signal, a metering signal, and a data signal and is capable of adding one or more of the received signals and providing it to the first and second line drivers 530, 535. The signals into the SUM block 550 may be subjected to different levels of gain for optimal performance. The signal from the DCIN terminal 565 is low-pass filtered. The current-sensing circuit 560 produces a current proportional to the current through the current sensing resistors 540, 545, subtracts a current proportional to a current from a cancellation terminal (CANC) 570, and provides the resulting current to an IMT terminal 575 of the SLIC 310. Although not so limited, in the instant embodiment, the constant of proportionality for the current from the cancellation terminal (CANC) 570 is unity, and the constant of proportionality for the metallic line current is 0.001. Those skilled in the art will appreciate that only those portions of the SLIC 310 deemed relevant to the invention are disclosed herein. The SLIC 310 may employ resistors or other circuitry that is not illustrated in FIG. 5A.

Although the SLIC 310 illustrated in FIG. 5A is a voltage-feed SLIC in which a voltage is applied to the subscriber loop and a resulting current is measured, it is contemplated that a current-feed SLIC may also be utilized in the line card 210 in accordance with the instant invention. In a current-feed SLIC, a current is fed to the subscriber loop and the measured electrical parameter is the resulting voltage.

As described above, the gain/bandwidth controller 320 is capable of applying a plurality of gains that correspond to a plurality of bandwidth requirements and signal accuracy. In one embodiment, the gain/bandwidth controller 320 is interfaced with the sum block 550 and processes communication signals as described above. In an alternative embodiment, the gain/bandwidth controller 320 can be integrated into the sum block 550. In yet another alternative embodiment, the gain/bandwidth controller 320 can be integrated into a digital signal processor (not shown) in the line card 210.

Turning now to FIG. 5B, a simplified block diagram illustrating the signal separation for performing separate gain control, in accordance with the present invention, is shown. The driver 527 is capable of driving a plurality of signals that are received from the sum block 550, onto a subscriber line 130. In one embodiment, the driver 527 is a differential driver that comprises the first and second differential line drivers 530, 535, and the first and second sensing resistors 540, 545 (as shown in FIG. 5A). The SLIC 310 comprises a plurality of gain function blocks 502-506 that are capable of performing a plurality of separate gain and filtering functions. Since the plurality of signals received by the SLIC 310 (e.g., DCIN, MTR, VIN, IMT, D_{DOWN}+, D_{DOWN}−, etc.) generally have different characteristics and requirements, separate gain function block 502-506 can be used to process the signals to conform to each characteristic and requirement of the signals. For example, the DCIN signal, which controls the DC feed and ringing signals, is generally driven by a low voltage chip. Therefore, in one embodiment, a gain of 150 is applied to the DCIN signal by the gain function block 502, so that the DCIN signal can control a 150 volts ringing signal.

In another example, a metering signal (MTR) is send through a gain factor of 13, which is applied by the gain function block 503. The gain function block 503 is capable of performing a gain factor of 13 and operating at a frequency of approximately 16 kiloHertz (kHz) signal. The VIN signal, which is a voice input signal, is sent through a gain factor of 5, which is applied by the gain function block 504. The IMT signal, which is also a voice input signal, is sent through a gain factor of 8, which is applied by the gain function block 505. The gain function blocks 504 and 505 comprise circuitry that is accurate and operational in a frequency range of approximately 300 Hz to 3400 Hz. The D_{DOWN}+, D_{DOWN}−signals, which are differential signals, are sent through a gain factor of 20, which is applied by the gain function block 506. The gain function block 506 is generally operational at a frequency range of approximately 140 kHz to approximately 1100 kHz. The gain function block 506 is also capable of operating under low distortion requirements

If the signals shown in FIG. 5B were processed together, the gain would have to set be set relatively high, while some signals would have to attenuated, resulting in excessive noise and accuracy errors. Furthermore, the high-gain circuits generally operate at higher speeds, causing further power consumption. Separating the signals and processing them individually before summing the signals allows for more accurate, less noisy, and more efficient processing of the signals. Furthermore, selective filtering and selective operation-currents can be implemented in any one of the gain function block 502-506, resulting in more efficient processing of the signals.

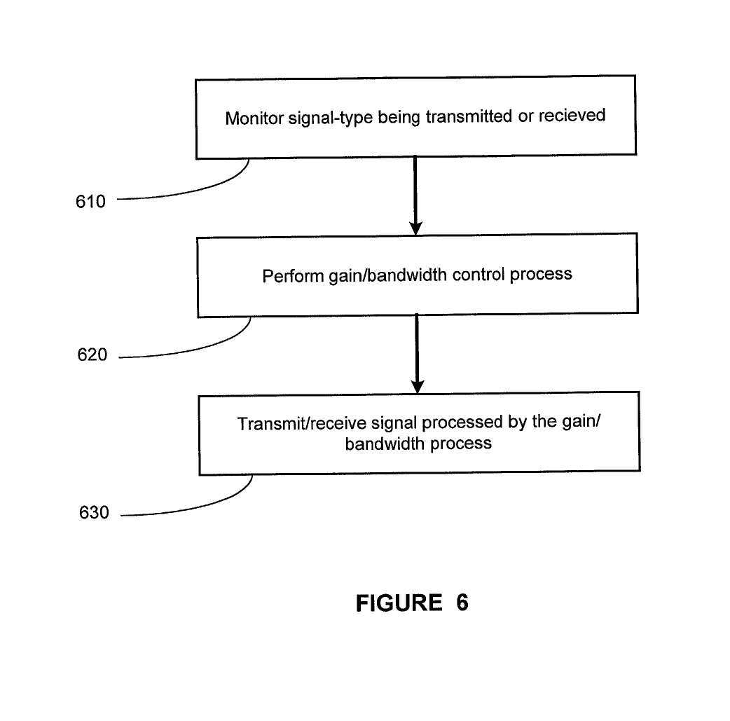

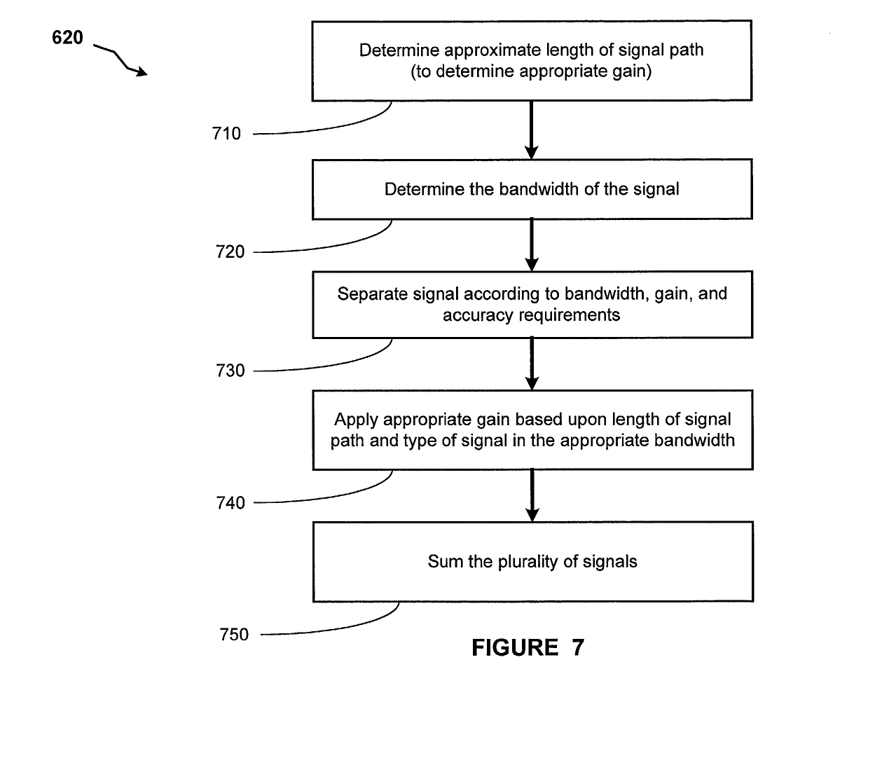

Turning now to FIG. 6, a flowchart depiction of one embodiment of the methods in accordance with the present invention is illustrated. The signal that is being transmitted or received by the line card 210 is monitored, as described in block 610 of FIG. 6. In one embodiment, the signal that is being transmitted or received by the line card 210 is monitored to determine the type of signal being received or transmitted, the bandwidth requirements of the signal, and the approximate length of the signal path which carries the signal. Subsequently, a gain/bandwidth control process is performed, as described in block 620 of FIG. 6. FIG. 7 illustrates a more detailed depiction of one embodiment of the gain/bandwidth control process described in FIG. 6.

Turning now to FIG. 7, an approximate length of the total signal path of the signal being analyzed is determined, as described in block 710. The bandwidth requirement of the signal that is being analyzed is determined, as described in block 720 of FIG. 7. For example, if a DC or a ringing signal is detected, the bandwidth requirement is approximately 100 Hertz to 200 Hertz. If a voice signal is detected, the bandwidth requirement is approximately 200 Hertz to 20 KiloHertz. As another illustrative example, if a data signal is detected, bandwidth requirement is approximately 500 KiloHertz to 5 MegaHertz. In one embodiment, the signals that are being analyzed are separated by bandwidth requirements, gain requirements, and accuracy requirements, as described in block 730 of FIG. 7.

Once the signals that are being analyzed are separated, an appropriate gain is applied to the separated signals, as described in block 740 of FIG. 7. For example for a data signal, a gain of approximately 10 is applied. For a voice signal, a gain of approximately 2 to 3 is applied. For a DC or a ringing signal, a gain of approximately 140 is applied. One the appropriate respective gains are applied to the signals, the signals are summed, as described in block 750 of FIG. 7. The completion of the steps described in FIG. 7 substantially completes the implementation of the gain/bandwidth control process described in block 620 of FIG. 6. Turning back to FIG. 6, once the gain/bandwidth control process is substantially complete the processed signal is transmitted from the line card 210, or received into the line card 210, as described in block 630 of FIG. 6.

The apparatuses 110, 120, 130 can be integrated in a system capable of transmitting and receiving signals having a voice band and a data band. The teachings of the present invention may be implemented in a line card 210 that supports both POTS and ADSL technologies.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of improving at least one gain bandwidth path, comprising:
monitoring at least one signal being transmitted; and
performing a gain/bandwidth control process upon said monitoring of said signal.

2. The method of claim 1, wherein monitoring at least one signal being transmitted further comprises determining whether said signal is a data signal.

3. The method of claim 1, wherein monitoring at least one signal being transmitted further comprises determining whether said signal is a voice signal.

4. The method of claim 1, wherein monitoring at least one signal being transmitted further comprises determining whether said signal is a DC signal.

5. The method of claim 1, wherein monitoring at least one signal being transmitted further comprises determining whether said signal is a ringing signal.

6. The method of claim 1, wherein performing a gain/bandwidth control process further comprises:
determining an approximate length of at least one signal path carrying said signal;
determining a bandwidth requirement of said signal path;
determining a gain factor to be applied upon said signal path;
separating said signal path in response to at least one of said approximate length of said signal path, said bandwidth requirement of said signal path, and said gain factor to be applied upon said signal path; and
applying an appropriate gain within said bandwidth upon said separated signal path.

7. The method of claim 6, further comprising summing said signal path in response to applying said gain upon said signal path to at least one other signal path.

8. The method of claim 6, wherein applying an appropriate gain within said bandwidth upon said separated signal path further comprises applying a gain of approximately 10 in a bandwidth of about 500 KiloHertz to about 5 MegaHertz in response to a determination that said signal path is a data signal path.

9. The method of claim 6, wherein applying an appropriate gain within said bandwidth upon said separated signal path further comprises applying a gain of approximately 3 in a bandwidth of about 200 Hertz to about 20 KiloHertz in response to a determination that said signal path is a voice signal path.

10. The method of claim 6, wherein applying an appropriate gain within said bandwidth upon said separated signal path further comprises applying a gain of approximately 140 in a bandwidth of about 100 Hertz to about 200 Hertz in response to a determination that said signal path is a DC signal path.

11. The method of claim 6, wherein applying an appropriate gain within said bandwidth upon said separated signal path further comprises applying a gain of approximately 140 in a bandwidth of about 100 Hertz to about 200 Hertz in response to a determination that said signal path is a ringing signal path.

12. An apparatus for improving at least one gain bandwidth path, comprising:
a first circuit portion capable of driving a signal onto a subscriber line; and
a second circuit portion electrically coupled with said first circuit portion, wherein said second circuit portion is capable of separating a plurality of signal paths based upon at least one characteristic of said signal path for applying an appropriate gain factor upon said signal path.

13. The apparatus of claim 12, wherein said first circuit portion further comprises at least one differential signal driver is capable of driving at least one of a voice signal, a data signal, a DC signal, and a ringing signal onto said subscriber line.

14. The apparatus of claim 12, wherein said subscriber line is a medium capable of transmitting signals.

15. The apparatus of claim 14, wherein said subscriber line is comprised of a subscriber loop.

16. The apparatus of claim 1, wherein said second circuit portion is a gain/bandwidth controller.

17. The apparatus of claim 16, wherein said gain/bandwidth controller further comprises:
a signal path separator capable of separating a signal path based upon at least one of said bandwidth requirement, signal accuracy requirement, and a signal path characteristic;
a plurality of gain/bandwidth circuits coupled with said signal path separator, said gain/bandwidth circuit being capable of applying an appropriate gain based upon said separation of said signal paths; and
a summer coupled with said plurality of gain/bandwidth circuits, said summer being capable of summing a plurality of signals from said plurality of gain/bandwidth circuits and producing an output signal.

18. A system for supporting voice band and data band communications, comprising:
a sum block capable of receiving at least one of a voice signal, a DC signal, a ringing signal, and a data signal;
at least one differential signal driver coupled to said sum block, wherein said differential signal drivers are capable of driving at least one of said voice signal, a DC signal, a ringing signal, and said data signal onto a subscriber line; and
a gain/bandwidth controller coupled with said sum block and said differential signal driver, wherein said gain/bandwidth controller is capable of separating at least one signal path and applying an appropriate gain upon a signal on said subscriber line.

19. The system of claim 18, wherein said sum block is capable of receiving at least one of a:
DC ring signal;
a metering signal;
a voice signal; and
a data signal.

20. The system of claim 19, wherein said sum block is capable of summing two or more of said DC ring signal, said metering signal, said voice signal, and said data signal.

21. The system of claim 19, wherein said subscriber line is a medium capable of transmitting signals.

22. The system of claim 19, wherein said subscriber line is comprised of a subscriber loop.

23. The system of claim 18, wherein said gain/bandwidth controller further comprises:
a signal path separator capable of separating a signal path based upon at least one of said bandwidth requirement, signal accuracy requirement, and a signal path characteristic;
a plurality of gain/bandwidth circuits coupled with said signal path separator, said gain/bandwidth circuit being capable of applying an appropriate gain based upon said separation of said signal paths; and
a summer coupled with said plurality of gain/bandwidth circuits, said summer being capable of summing a plurality of signals from said plurality of gain/bandwidth circuits and producing an output signal.

24. A method of improving at least one gain bandwidth path, comprising:
means for monitoring at least one signal being transmitted; and
means for performing a gain/bandwidth control process upon said monitoring of said signal.
